(19) United States
(12) Patent Application Publication
(10) Pub. No.: US 2026/0164422 A1
(43) Pub. Date: Jun. 11, 2026

(54) METHOD, SYSTEM, AND APPARATUS FOR UPLINK WIRELESS COMMUNICATIONS

(71) Applicant: Huawei Technologies Co., Ltd., Shenzhen (CN)

(72) Inventors: Yu Cao, Kanata (CA); Huazi Zhang, Kanata (CA); Jianglei Ma, Ottawa (CA)

(21) Appl. No.: 19/409,307

(22) Filed: Dec. 4, 2025

Related U.S. Application Data
(63) Continuation of application No. PCT/CN2024/091756, filed on May 8, 2024.
(60) Provisional application No. 63/506,519, filed on Jun. 6, 2023.

(51) Int. Cl. H04W 72/115; H04W 72/21

(52) U.S. Cl. CPC H04W 72/115; H04W 72/21

(57) ABSTRACT

A method, a system, and an apparatus for uplink wireless communication are provided. the method includes a first communication device decides to transmit first traffic data in a first resource overlapping with a second resource to a second communication device. The second resource is scheduled by the second communication device for transmission of second traffic data by the first communication device. The first communication device can send the first traffic data (for example, the URLLC traffic data) quickly and reliably according the method.

### CROSS-REFERENCE TO RELATED APPLICATIONS

The present application is a continuation of International Application No. PCT/CN2024/091756, filed on May 8, 2024, which claims the benefit of U.S. Provisional Patent Application No. 63/506,519, filed on Jun. 6, 2023.

The disclosures of the aforementioned applications are hereby incorporated by reference in their entireties.

### TECHNICAL FIELD

The present application relates to wireless communications.

### BACKGROUND

Resilience is a fundamental feature that needs to be addressed in sixth generation (6G) communications. With the evolution of Industry 4.0 and many other technology visions, ultra-reliable and low latency wireless communications are a pivotal enabler for automated manufacturing on a massive scale.

Two trends are observed in recent developments toward 6G. From the technological perspective, millimeter-wavelength (mmWave) communications and massive multiple input multiple output (MIMO) will be more prevalent because they can significantly expand the current bandwidth resource. From the service perspective, a single communication device will need to support multiple services with different latency and reliability requirements. The two trends, together with the more stringent resilience requirement, provide an opportunity to re-design the physical layer.

A potential scenario emerges as multiple services converge into one physical wireless link. The purpose is to deliver multiple quality of service (QoS) levels to multiple services within only one wireless link. Given the high carrier frequency and massive antennas, beamforming can be done more aggressively, enabling the convergence of multiple services in one wireless link. Meanwhile, these services may have very diverse key performance indicators (KPIs). As shown below, ultra-reliable low latency communications (URLLC), massive machine type communications (mMTC), enhanced mobile broadband (eMBB) and terabit per second (Tbps) communications may all be integrated in one beam or one link. This is challenging because different KPIs, for example, signal to noise ratio (SNR), fading, etc., must be supported under the same wireless channel.

In future cellular systems, when both eMBB and URLLC are supported, eMBB traffic usually occupies a large block of time frequency resources; while URLLC traffic, when arrives, needs to be transmitted immediately. In order to allow URLLC traffic to have resources to be scheduled immediately with high reliability, a large amount of time frequency resources can be reserved for URLLC and to be scheduled for other traffic. However, this workaround is a very inefficient use of the spectrum resources as URLLC traffic does not occur frequently. Therefore, it is essential to have some mechanism to re-use eMBB resource for URLLC.

### SUMMARY

The present disclosure encompasses embodiments that may be useful in addressing various technical shortcomings of current uplink wireless communication methods. In new radio (NR) communication systems, a mechanism exists for multiplexing eMBB and URLLC traffic. The mechanism operates by means of re-using scheduled eMBB resources for URLLC. In downlink (DL), a DL preemption indication (PI) mechanism has been used in NR. In uplink (UL), a similar but different mechanism called UL cancellation indication (CI) mechanism has been used in a later release of NR. In UL CI mechanism, when a base station (BS) schedules a user equipment (UE) for eMBB transmission in UL, and then another UE (for example, called URLLC UE) has URLLC traffic to transmit, the BS will send downlink control information (DCI) to schedule the URLLC traffic on the resource that overlaps with the previously scheduled eMBB resources. Then, since the eMBB transmission may be in conflict with the URLLC transmission, the BS sends CI to the eMBB UE that is transmitting the eMBB traffic to cancel the rest of the eMBB transmission that conflicts with the URLLC transmission. For intra-UE, the UL CI mechanism is also adapted. Here the intra-UE refers to a scenario, where the eMBB traffic and URLLC traffic are from the same UE. The UL CI mechanism may resolve a potential conflict between eMBB and URLLC traffic by re-using the eMBB resource.

However, it is challenging for the UE to send the URLLC traffic quickly and reliably when the URLLC resource conflicts with or partially overlaps with the scheduled eMBB resources. For example, there may not be enough time for the BS to send DCI to schedule the URLLC transmission as the UE also needs processing time after receiving the DCI, resulting in that the URLLC transmission may not meet low-latency requirements. Also, there may not be enough time for the BS to send CI to cancel the rest of the eMBB transmission, resulting in that the eMBB transmission may conflict with the URLLC transmission.

In some embodiments of the present disclosure, a first communication device (for example, a UE) can send first traffic data (for example, URLLC traffic data) quickly and reliably when the resource of the first traffic data conflicts with or partially overlaps with the scheduled resources for second traffic data (for example, eMBB traffic data) by making decisions to transmit the first traffic data rather than waiting for DCI or other indicators from a second communication device (for example, a BS). The first communication device can send first information such that the second communication device is able to decode the first traffic data. That is, the first communication device can inform the second communication device about the changes in transmission.

According to an aspect of the present disclosure, a method involves deciding to transmit, by a first communication device to a second communication device in a wireless communication network, first traffic data in a first resource overlapping with a second resource, where the second resource is scheduled for transmission of second traffic data by the second communication device; sending, by the first communication device to the second communication device, first information such that the second communication device is able to decode the first traffic data.

A related method may involve receiving, by a second communication device from a first communication device in a wireless communication network, first traffic data in a first resource overlapping with a second resource, where the second resource is scheduled for transmission of second traffic data by the second communication device; receiving, by the second communication device from the first communication device, first information; decoding the first traffic data according to the first information.

In apparatus embodiments, an apparatus may include a processor and a non-transitory computer readable storage medium that is coupled to the processor. The non-transitory computer readable storage medium stores program for execution by the processor.

A storage medium needs not necessarily only be implemented in or in conjunction with such an apparatus. A computer program product, for example, may be or include a non-transitory computer readable medium storing a program for execution by a processor.

A program stored by a computer readable storage medium may include instructions to, or to cause a processor to, perform, implement, support, or enable any of the methods disclosed herein.

For example, the program may include instructions to, or to cause a processor to: decide to transmit, by a first communication device to a second communication device in a wireless communication network, first traffic data in a first resource overlapping with a second resource, where the second resource is scheduled for transmission of second traffic data by the second communication device; send, by the first communication device to the second communication device, first information such that the second communication device is able to decode the first traffic data.

A program may include instructions to, or to cause a processor to: receive, by a second communication device from a first communication device in a wireless communication network, first traffic data in a first resource overlapping with a second resource, where the second resource is scheduled for transmission of second traffic data by the second communication device; receive, by the second communication device from the first communication device, first information; decode the first traffic data according to the first information.

According to yet another embodiment, a system includes a first communication device and a second communication device. The first communication device is configured to decide to transmit, to a second communication device in a wireless communication network, first traffic data in a first resource overlapping with a second resource, where the second resource is scheduled for transmission of second traffic data by the second communication device. The first communication device is further configured to send, to the second communication device, first information such that the second communication device is able to decode the first traffic data. The second communication device is configured to receive, from a first communication device in a wireless communication network, first traffic data in a first resource overlapping with a second resource, where the second resource is scheduled for transmission of second traffic data by the second communication device. The second communication device is further configured to receive, from the first communication device, first information. The second communication device is further configured to decode the first traffic data according to the first information.

According to yet another embodiment, a computer program product includes program including one or more instructions to perform any of the methods disclosed herein.

According to yet another embodiment, an apparatus, including a function or unit to perform any of the methods disclosed herein.

According to yet another embodiment, a computer readable storage medium, including one or more instructions, where when the one or more instructions are run on a computer, the computer performs any of the methods disclosed herein.

The present disclosure encompasses these and other aspects or embodiments.

### DESCRIPTION OF DRAWINGS

For a more complete understanding of the present embodiments, and the advantages thereof, reference is now made, by way of example, to the following descriptions taken in conjunction with the accompanying drawings.

FIG. 1 is a simplified schematic diagram of a communication system.

FIG. 2 is a block diagram illustrating the example communication system in FIG. 1.

FIG. 3 illustrates an example electronic device and examples of base stations.

FIG. 4 illustrates units or modules in a device.

FIG. 5 is a block diagram illustrating an example multi-service scenario.

FIG. 6 is a block diagram illustrating a DL PI mechanism.

FIG. 7 is a block diagram illustrating a UL CI mechanism.

FIG. 8 is a flow diagram illustrating an example method according to an embodiment.

FIG. 9 is a block diagram illustrating first information and/or second information indicating mixed traffic coding afterwards.

FIG. 10 is a block diagram illustrating first information and/or second information to be transmitted together with a first traffic.

FIG. 11 is a block diagram illustrating a multiplexing/encoding embodiment.

FIG. 12 is a block diagram illustrating self-decoding and joint-decoding in the event of a self-decoding failure.

FIG. 13 is a block diagram illustrating a robot arm that includes a video device and two joints communicates with a base station.

FIG. 14 is a block diagram illustrating an example code block and encoded symbols according to an embodiment.

FIG. 15 is a block diagram illustrating an example code block and encoded symbols according to another embodiment.

FIG. 16 is a block diagram illustrating an example code block and encoded symbols according to a further embodiment.

FIG. 17 is a block diagram illustrating sequential coupling of bits between individual payloads.

FIG. 18 is a block diagram illustrating multi-to-one coupling of bits between individual payloads.

### DESCRIPTION OF EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

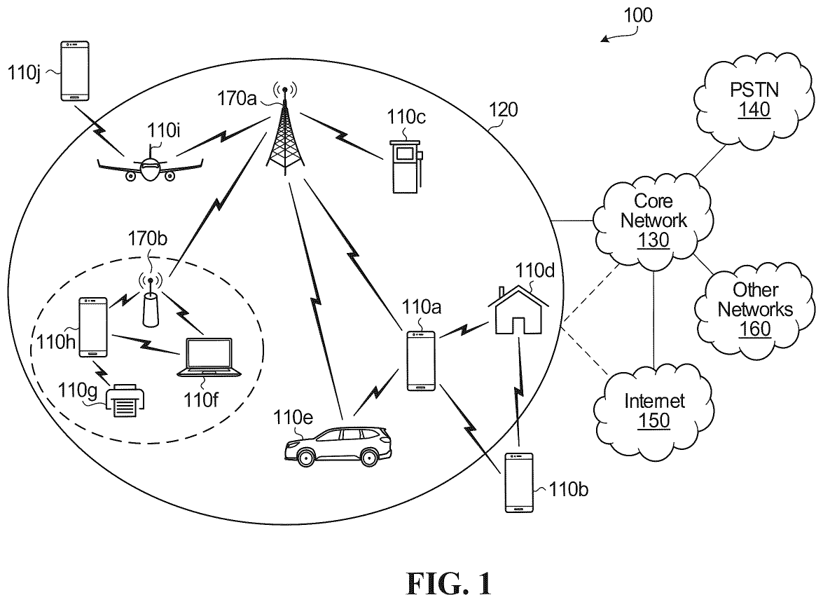

Referring to FIG. 1, as an illustrative example without limitation, a simplified schematic diagram of a communication system is provided. The communication system 100 includes a radio access network 120. The radio access network 120 may be a next generation (e.g., sixth generation, “6G,” or later) radio access network, or a legacy (e.g., 5G, 4G, 3G or 2G) radio access network. One or more communication electric devices (EDs) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 may include public switched telephone network (PSTN) 140, the internet 150, and other networks 160.

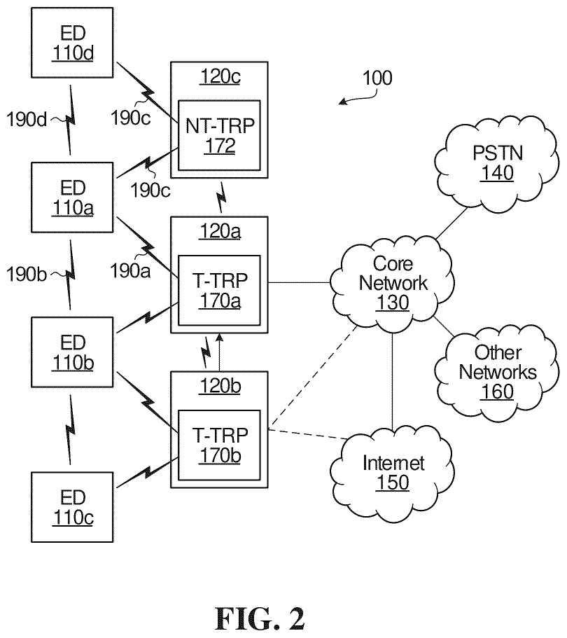

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes EDs 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

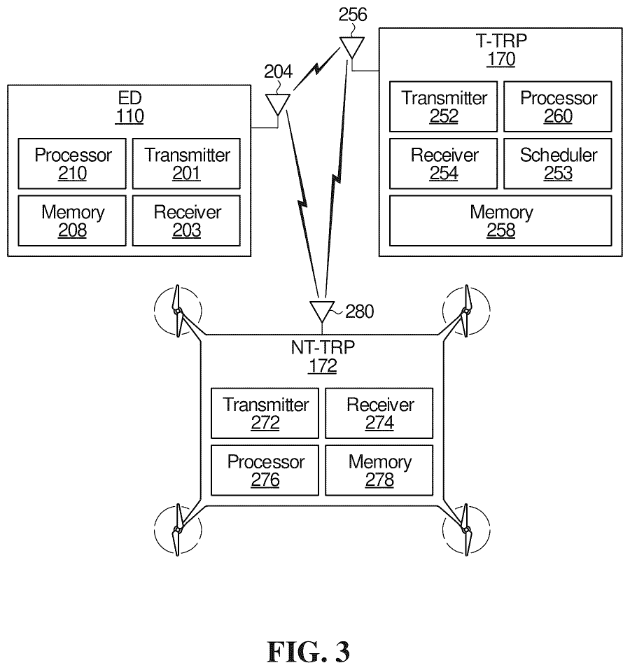

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each are T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned on (i.e., established, activated or enabled), turned off (i.e., released, deactivated or disabled) and/or configured in response to one or more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 can store software instructions or modules that are configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating beamforming and transmit a beam and generating symbols for transmission. Processing operations related to processing downlink transmissions may include operations such as receive the beam, demodulating and decoding received symbols. Depending upon the embodiment, a downlink transmission may be received by the receiver 203, possibly using receive the beam, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit the beam and/or the receive the beam based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit a beam and generating symbols for transmission. Processing operations related to processing received transmissions in the uplink or over backhaul may include operations such as receive the beam, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 can store software instructions or modules that are configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit a beam and generating symbols for transmission. Processing operations related to processing received transmissions in the uplink or over backhaul may include operations such as receive the beam, demodulating received signals and decoding received symbols. In some embodiments, the processor 276 implements the transmit a beam and/or receive the beam based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

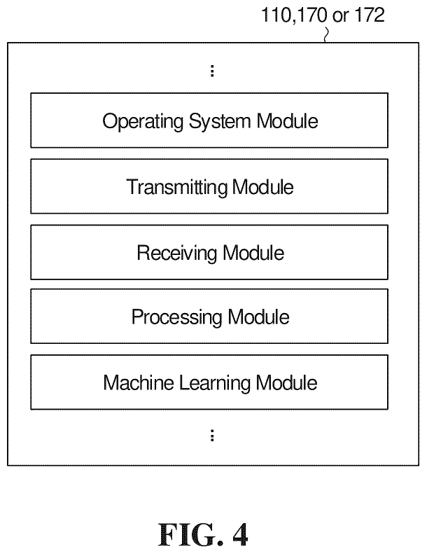

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

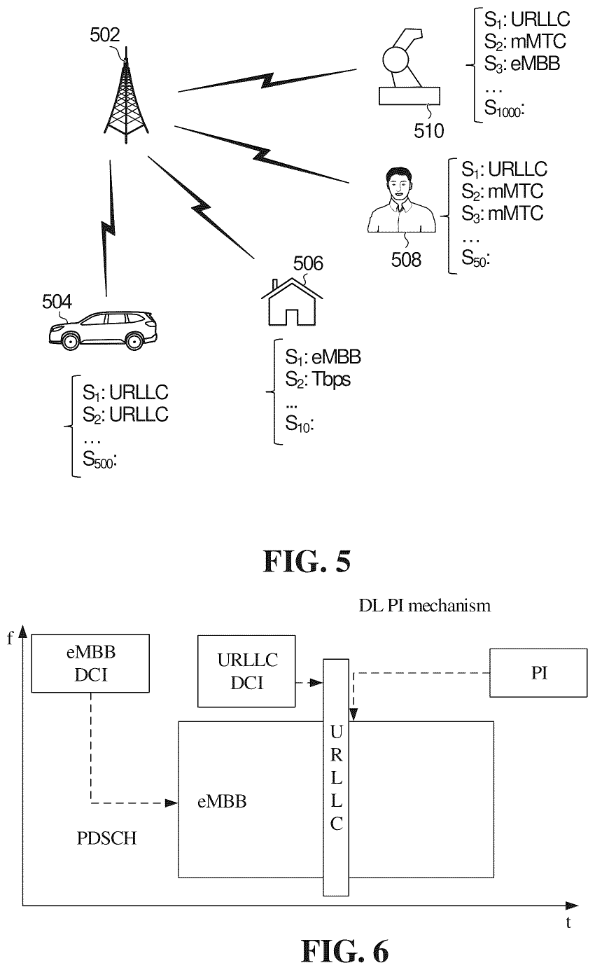

As referenced above, multiple services may converge or be integrated into one physical wireless link, and these services may have diverse key performance indicators (KPIs). FIG. 5 is a block diagram illustrating an example multi-service scenario, in which services integrated into one link may include any of URLLC, mMTC, eMBB, and Tbps services. In FIG. 5, communication devices include a network device 502, a vehicle-based device represented at 504, a home-based or other premises-based device represented at 506, a user device represented at 508, and an industrial or machine-based device represented at 510, each with example services as shown.

The present disclosure is not limited to these or any other types of devices or services. FIG. 5 is intended to provide one example scenario in which embodiments disclosed herein may be particularly useful. More generally, disclosed embodiments may be implemented, for example, in next-generation mobile and wireless network services, cloud and edge computing services, and sensing services. Some embodiments may be particularly useful for automated manufacturing systems in smart factories, and/or other intelligent vertical scenarios such as ports, delivery systems, and medical systems. These possible applications of embodiments are also illustrative and non-limiting examples.

A multi-service scenario, such as the scenario shown by way of example in FIG. 5, may be considered as a form of intra-user equipment (UE) multiple access (MA). Intra-UE MA refers to concurrent transmissions of multiple services from one terminal device.

FIG. 6 is a block diagram illustrating the DL PI mechanism. The horizontal solid line represents time resources, and the vertical solid line represents frequency resources as shown in FIG. 6. In this scenario, it is assumed that a BS may have scheduled the eMBB traffic by sending eMBB DCI to a UE in advance. The dashed arrow pointing from the eMBB DCI to eMBB resources in FIG. 6 represents that the eMBB DCI configures eMBB resources. Then the URLLC traffic arrives for the UE or another UE, where the UE that was transmitting eMBB traffic may be called the eMBB UE, and the UE that will transmit URLLC traffic may be called the URLLC UE. In some scenarios, the eMBB UE and the URLLC UE are the same. In other scenarios, the eMBB UE and the URLLC UE are two different UEs. However, there may be not enough empty resources to schedule the URLLC traffic, so the BS schedules the URLLC on a resource that overlaps with the previously-scheduled eMBB traffic as shown in FIG. 6 by sending URLLC DCI to the URLLC UE. Since the BS is aware of the URLLC traffic, the BS can decide to puncture the eMBB transmission on the resources that overlaps with URLLC to guarantee the reliability of URLLC transmission (i.e., not transmit the eMBB data on the resources overlapping with the URLLC transmission). However, the eMBB UE is unaware that its data has been punctured and may expect eMBB data on the punctured resources (the eMBB UE has received eMBB DCI indicating eMBB data on the punctured resources from the BS before URLLC traffic arrives); thus, the eMBB UE may interpret the signal received for the URLLC traffic as the originally-intended eMBB signal, which will significantly reduce the probability of decoding the entire eMBB traffic and may trigger hybrid automatic repeat request (HARQ). Therefore, the BS may decide to send a preemption indication (PI) signal afterwards (i.e., after the puncturing) to inform the eMBB UE that part of the eMBB transmission is punctured. The dashed arrow pointing from the PI to eMBB resources in FIG. 6 represents that the BS sends the PI to the eMBB UE. The PI signal is sent in group-common (GC)-PDCCH. Although the eMBB UE is still missing the part of eMBB signal, the PI signal provides the eMBB UE with the knowledge of the puncturing, so the eMBB UE has a better understanding of the signal, which improves the probability of decoding all or part of the eMBB messages.

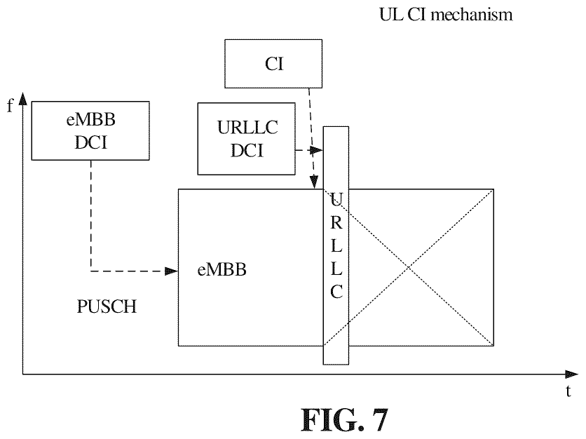

FIG. 7 is a block diagram illustrating the UL CI mechanism. The UL CI mechanism is a similar mechanism proposed for uplink in a later release of NR. However, in uplink, it is a lot more difficult to have such a mechanism as the data is transmitted by the UE.

Similarly, when the BS first schedules a UE for eMBB transmission in uplink in a physical uplink shared channel (PUSCH), and then the UE or another UE has URLLC traffic to transmit. The BS will schedule the URLLC traffic using URLLC DCI on the resource that overlaps with the previously scheduled eMBB resources as shown in FIG. 7. Note that, for the BS to know that the UE has URLLC traffic to transmit, the URLLC UE may have sent a scheduling request (SR) to indicate to the BS that the UE has URLLC traffic data to send. Because the eMBB transmission may be in conflict with the URLLC transmission, the BS then sends a cancellation indication (CI) through GC-PDCCH to the eMBB UE to cancel the rest of the eMBB transmission that conflicts with the URLLC resource; and this process guarantees the reliability of URLLC transmission. The dotted X mark on a part of the eMBB resources after the URLLC resources represents that the rest of the eMBB transmission that conflicts with the URLLC resource or after the URLLC resource is canceled. However, this approach requires all of the message exchange between the BS and the UE(s), as well as the processing of the message by the eMBB UE, to happen before the eMBB UE cancels the rest of the eMBB transmission. This pre-cancellation message exchange may further include the URLLC UE sending an SR, the BS sending DCI to schedule the URLLC transmission, and the BS sending a CI to the eMBB UE. Therefore, it is a lot more difficult for the UL CI mechanism to be as effective as in the DL scenario.

The UL CI mechanism for resolving a potential conflict between eMBB and URLLC traffic when the resource re-used suffers from the following disadvantages. Firstly, the BS needs to have enough time to send DCI (or a CI) to the eMBB UE and the eMBB UE needs to have enough time to process the command after receiving the DCI (or the CI) to successfully cancel the eMBB transmission. Secondly, puncturing/dropping eMBB is not efficient for an intra-UE eMBB traffic since there is a more efficient coding scheme for the intra-UE. Here the intra-UE refers to the scenario, where the eMBB traffic and the URLLC traffic are from the same UE. For a grant free (GF) or a configured grant (CG) based URLLC transmission, the BS may not know the URLLC traffic through scheduling a request (SR) in advance since the URLLC UE may not send the SR.

Some embodiments of the present disclosure are directed to a UL intra-UE eMBB URLLC traffic conflict handling problem. In this scenario, the BS has already scheduled an eMBB transmission for a UE, and then URLLC traffic arrives for that same UE (i.e., intra-UE scenario) after the eMBB transmission is scheduled and before the eMBB transmission is finished. There may not be enough time for the UE to send an SR for the URLLC transmission. Thus, it is challenging for the UE to send the URLLC resource quickly and reliably, without much negative impact on the eMBB transmission. The URLLC resource may conflict with or partially overlap with the scheduled eMBB resources.

It is noted that the examples in the present disclosure may focus on URLLC and eMBB traffic. However, they are just examples of two different traffic types with different priorities. In practice, the above-mentioned mechanisms and the method in the present disclosure may be applicable to two different data traffic types that may be other than URLLC and eMBB, or may not necessarily be specified traffic types. In addition, those skilled in the art will understand that the above-mentioned mechanisms and the method in the present disclosure may be applicable or extended to conflict handling of more than 2 traffic types.

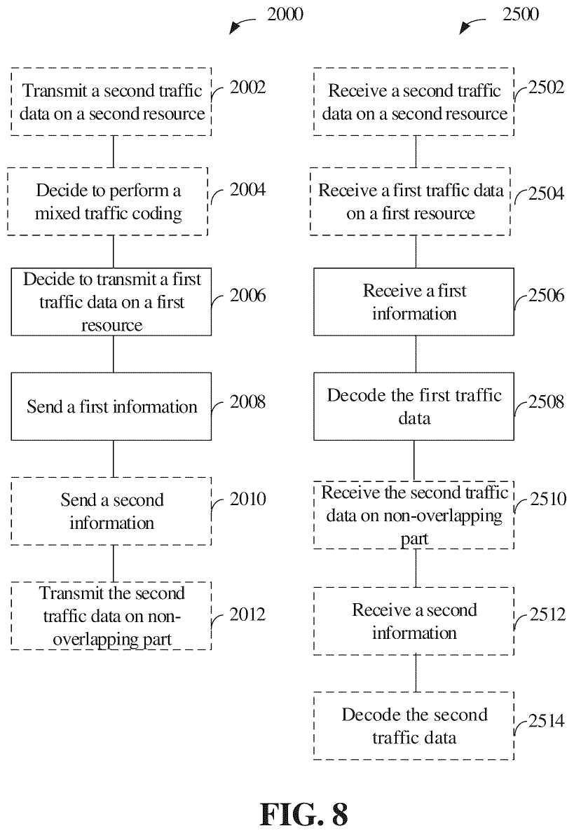

FIG. 8 is a flow diagram illustrating an example method according to an embodiment. At the left, 2000 in FIG. 8 illustrates operations or features that may be provided or supported at a transmitter-side device, and at the right, 2500 illustrates operations or features that may be provided or supported at a receiver-side device. For ease of reference, in the following description of FIG. 8, a device at which encoding and/or transmitting features may be implemented or supported is called a first communication device, and a device at which decoding and/or receiving features may be implemented or supported is called a second communication device. Embodiments may involve either or both of such devices.

With reference first to 2000, from a transmitting device perspective, 2006 is intended to represent deciding to transmit first traffic data in a first resource by a first communication device to a second communication device in a wireless communication network. Correspondingly, with reference first to 2504, from a receiving device perspective, 2502 is intended to represent receiving the first traffic data in the first resource.

The first communication device may be a UE, for example, any ED 110 in FIG. 1. The second communication device may be a BS, for example, RAN 120a or RAN 120b in FIG. 1. For ease of reference, the present disclosure may be described with the UE and the BS in the following contents. But note that, the UE is only an example of the first communication device without limitation, and the first communication device may be other devices. Similarly, the BS is only an example of the second communication device without limitation, and the second communication device may be other devices.

The first traffic data is one kind of traffic data, such as URLLC traffic data. The second traffic data is another kind of traffic data, such as eMBB traffic data. Traffic data may equal to or be substituted by other terms, for example, traffic, data, message, information bits, and so on. For ease of reference, the present disclosure may be described with the URLLC traffic data instead of the first traffic data, and the eMBB traffic data instead of the second traffic data in the following contents. But note that, the URLLC traffic data is only an example of the first traffic data without limitation. Similarly, the eMBB traffic data is only an example of the second traffic data without limitation.

Transmission of the second traffic data is scheduled on a second resource by the second communication device. In other words, the second communication device has already scheduled or configured the second resource for the second traffic data. In some embodiments, the method 2000 further includes operation 2002. At 2002, FIG. 8 illustrates transmitting, by the first communication device to the second communication device, the second traffic data on the second resource. Correspondingly, the method 2500 further includes operation 2502 that is intended to represent receiving, by the second communication device from the first communication device, the second traffic data on the second resource.

Then, the first traffic data arrives for the first communication device before the transmission of the second traffic data is finished. There may not be enough time for transmission of the first traffic data, so the first communication device decides to transmit the first traffic data in a first resource.

The first resource is overlapped with the second resource. As an example, a part of the first resource is a portion of the second resource, and other part of the first resource does not overlap with the second resource. As another example, the first resource belongs to the second resource. In other words, the second resource includes the first resource, or the first resource is a part of the second resource. In some embodiments, the first resource is configured in advance. For example, in grant free (GF) or configured grant (CG) transmission, the GF or CG resource can be semi-statically configured or semi-persistently scheduled in advance, that is, the first resource is configured for grant free transmission or configured grant transmission. The first communication device may decide to use a part of all the GF or CG resource as the first resource to transmit the first traffic data. In some other embodiments, there may be no resource scheduled or configured in advance for the first communication device to transmit the first traffic data, and the first communication device may decide to use a part of the second resource as the first resource to transmit the first traffic data.

In some embodiments, after the first communication device decides to transmit the first traffic data in the first resource, the first communication transmits the first traffic data in the first resource, or the first communication starts to transmit the first traffic data in the first resource.

Operation 2006 is intended to represent sending, by the first communication device to the second communication device, first information such that the second communication device is able to decode the first traffic data. Correspondingly, operation 2506 is intended to represent receiving, by the second communication device from the first communication device, first information. Then, operation 2508 is intended to represent decoding the first traffic data according to the first information.

The first information may inform the second commutation device that something is changed on a part of the second resource or the transmission of the second resource. In some embodiments, the first information may further indicate any parameters needed for the second communication device to decode the first traffic data. As an example, the first information is an uplink control information (UCI), loaded in UCI or indicated by UCI.

According to the embodiments, the first communication device does not wait for an indicator from the second communication device, and decides to transmit the first traffic data in the first resource, even if the first resource is overlapped with the scheduled second resource. Therefore, the first communication device can send the first traffic data (for example, the URLLC traffic data) quickly and reliably. Also, the first communication device can send the first information such that the second communication device is able to decode the first traffic data. Therefore, the second communication device can decode the first traffic data (for example, the URLLC traffic data) reliably.

In some embodiments, the method 2000 may involve, at 2012, transmitting, by the first communication device to the second communication device, the second traffic data in a portion of the second resource that does not overlap with the first resource. Correspondingly, the method 2500 may involve, at 2510, receiving, by the second communication device from the first communication device, the second traffic data in a portion of the second resource that does not overlap with the first resource.

After the transmission of the first traffic data, the transmission of the second traffic data may resume on the part of the second resource that does not overlap with the first resource, since the part of the second resource that overlaps with the first resource was used for the transmission of the first traffic data.

According to the embodiments, the first communication device can use the part of the second resource that does not overlap with the first resource for transmitting the second traffic data, which will decrease the influence on the transmission of the second traffic data, and improve the continuity of communication between the first communication device and the second communication device.

In some embodiments, the second traffic data is transmitted or received in a codeword generated by encoding a part or all of a message of the first traffic data and a message of the second traffic data together. In other words, the codeword for the transmission of the second traffic data was generated by mixed-traffic coding.

In some embodiments, the method may involve, at 2004, deciding to encode the part or all of the message of the first traffic data and the message of the second traffic data together. In other words, 2004 is intended to represent deciding to perform mixed-traffic coding at the second resource. For example, the first traffic data encoding is unchanged compared to the case of encoding the first traffic data without mixed traffic coding; and for the second traffic data encoding, part of all of the message of the first traffic data is first embedded or added to the message (or information bits), and then encoded together using the same code that is originally used for encoding the second traffic data. But note that, all other mixed traffic coding methods, as described elsewhere in this disclosure, can also be employed.

According to the embodiments, the first communication device may decide to perform mixed-traffic coding at the second resource. If the first data cannot be decoded successfully by the second communication device at the first time, decoding the second data can enhance the decoding performance of the first traffic data, so the second communication device may decode the first data successfully later.

In some embodiments, the method 2000 may involve, at 2010, sending, by the first communication device to the second communication device, second information such that the second communication device is able to decode the codeword of the second traffic data. Correspondingly, the method 2500 may involve, at 2512, receiving, by the second communication device to the first communication device, second information. Also, the method 2500 may further involve, at 2514, decoding the codeword of the second traffic data according to the second information.

The second information may inform the second communication device that something is changed on a part of the second resource or the transmission of the second resource. In some embodiments, the second information may further indicate any parameters needed for the second communication device to decode the codeword of the second traffic data. For example, the second information is UCI, loaded in UCI or indicated by UCI. As an example, the second information and the first information may be loaded in the same indicator, such as the same UCI. As another example, the second information and the first information may be sent at the same time in the same or different UCI(s). That is, the second information may be sent along with the first information.

In some embodiments, the first information may help the second communication device decode the codeword of the second traffic data. In some embodiments, the second information may also help the second communication device decode the first traffic data. That is, the first information may have the function of the second information; and/or the second information may have the function of the first information. In some embodiments, operation 2008 and operation 2010 are regarded as one operation. For example, operation 2008 may represent sending by the first communication device to the second communication device, first information such that the second communication device is able to decode the first traffic data and the codeword of the second traffic data.

According to the embodiments, the first communication device can send the second information such that the second communication device is able to decode the codeword of the second traffic data. Therefore, the second communication device can decode the second traffic data (for example, the eMBB traffic data) reliably.

In some embodiments, the first information is sent or received after the transmission of the first traffic data. For example, after the transmission of the first traffic data is done, the UE can send UCI afterwards. The UCI is the first information, or has it, or indicates it. As an example, the first information is sent or received in a physical uplink control channel (PUCCH), a physical uplink shared channel (PUSCH) or a medium access control-control element (MAC-CE). When sent in a PUSCH, the first information may be multiplexed with uplink shared channel (UL-SCH) data to transmit together on the PUSCH.

Similarly, in some embodiments, the second information is sent or received after the transmission of the first traffic data. For example, after the transmission of the first traffic data is done, the UE can send UCI afterwards. The UCI is the second information, or has it, or indicates it. As an example, the second information is sent or received in a PUCCH, a PUSCH or a MAC-CE. When sent in a PUSCH, the second information may be multiplexed with UL-SCH data to transmit together on the PUSCH.

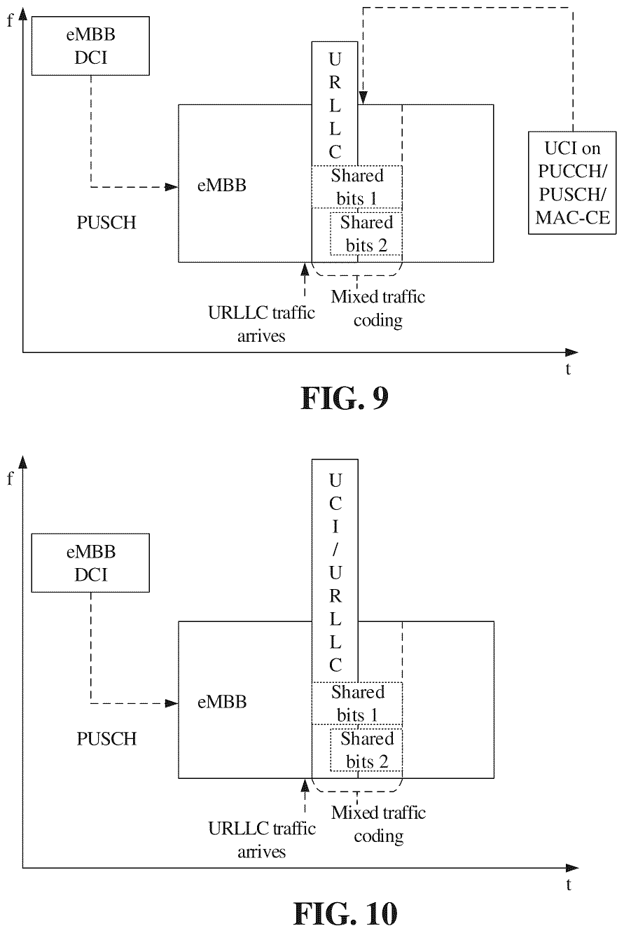

FIG. 9 is a block diagram illustrating the first information and/or the second information indicating mixed traffic coding afterwards. Herein, the first communication device is taken a UE as an example, and the second communication device is taken a gNB or a BS as an example. Also, the first traffic data is taken URLLC traffic data as an example, and the second traffic data is taken eMBB traffic data as an example. Note that, the following description about FIG. 9 will not limit the present disclosure.

In brief, FIG. 9 may aim at the scenarios as follows. The gNB has already scheduled the eMBB transmission by an eMBB DCI as shown in FIG. 9 with dash-line arrow pointing the eMBB resource. The URLLC traffic data arrives during eMBB transmission as shown in FIG. 9 with dash-line arrow pointing the eMBB resource. However, there may not be enough time for the UE to send an SR and wait for the BS to schedule the URLLC transmission. And GF resource is available (but overlapped with eMBB transmission) or no GF resource configured.

In brief, here are solutions as follows. The UE decides to perform mixed traffic coding at the eMBB resources. The URLLC traffic data will be transmitted at overlapped GF resource if configured. UCI is sent afterwards in PUCCH or PUSCH, or UL MAC-CE to inform BS about the changes in the transmission of eMBB.

FIG. 9 illustrates a mechanism for the UCI assisted mixed-traffic coding solution. In this scenario, the BS has already scheduled the eMBB transmission for the UE and the URLLC traffic data arrives for the same UE (intra-UE) after the eMBB transmission is scheduled, and before the eMBB transmission is finished. In some scenarios, there may not be enough time for the UE to send an SR for the URLLC transmission. Or in some other scenarios, even if the UE has time to send an SR for the URLLC transmission, the BS may not have enough time to send DCI to schedule the URLLC transmission that overlaps with the eMBB resource as the UE also needs processing time after receiving the DCI.

For the resource for the URLLC traffic data, i.e. the first resource, there may be a URLLC resource that has already been configured in advance. For example, in grant free (GF) or configured grant (CG) transmission, the GF or CG resource can be semi-statically configured or semi-persistently scheduled in advance. The GF or CG resource is available for the URLLC transmission; however, the GF or CG resource may overlap with the scheduled eMBB resource, i.e. the second resource. In another scenario, there may be no resource scheduled or configured in advance for the UE to transmit URLLC data.

After URLLC traffic data arrives, the UE performs joint mixed traffic coding of the URLLC and the eMBB traffic data. After transmission is done, the UE may send UCI, namely the first information that is helpful to decode the first traffic data and the second information that is helpful to decode the codeword of the second traffic data, or includes the first information and the second information, afterwards to inform the BS that mixed traffic coding is performed as well as provide information to help BS decode the URLLC and eMBB traffic data. In some embodiments, the UCI may inform BS about the joint mixed traffic coding as well as indicate any parameters needed for the BS to decode URLLC and eMBB data. In some embodiments, the UCI can be sent in a PUCCH or PUSCH channel, or the UCI can be sent in a MAC-CE, which may be part of an uplink PUSCH data transmission. When sent in a PUSCH, the UCI can also be multiplexed with a UL-SCH data to transmit together on the PUSCH. FIG. 9 illustrates the UCI with a dash-line arrow pointing to the URLLC resource and the eMBB resource, meaning that the UCI can indicate the changes in the URLLC traffic data and the eMBB traffic data.

In the example of mixed traffic coding described above, mixed traffic coding between the URLLC and eMBB traffic data may be performed as follows: the URLLC traffic data encoding is unchanged compared to the case of encoding the URLLC traffic data without mixed traffic coding; and for the eMBB traffic data encoding, a part or all of the URLLC message, i.e. the message of the first traffic data, is first embedded or added to the eMBB information bits, i.e. the message of the second traffic data, and then encoded together using the same code that is originally used for the eMBB traffic data encoding. However, all other mixed traffic coding methods, as described elsewhere in this disclosure, can also be employed.

In some scenarios, if there are resources configured that can be used for the URLLC traffic data (e.g. in the GF or CG transmission) to satisfy its latency requirement, the UE can perform the URLLC transmission on the configured resources. The configured URLLC resources may be overlapped (fully or partially overlapped) with the eMBB resources. But note that although there is no overlap between the configured URLLC resource and the scheduled eMBB resource, one can still perform a mixed traffic coding scheme in eMBB resources.

In other scenarios, if there are no scheduled and no configured resources (outside of the scheduled eMBB resources) available to transmit the URLLC traffic data, the UE may decide to use a part of the scheduled eMBB resource to transmit URLLC and to perform joint mixed traffic coding on a part or all of the rest of the scheduled eMBB resources. After the transmission is done, UE can send an UCI afterwards to inform BS about the joint mixed traffic coding as well as indicating any parameters needed for the BS to decode URLLC and eMBB data.

Mixed traffic coding may be performed by sharing a part or all of the payload (or the message) of the URLLC traffic data into the eMBB traffic data to perform joint encoding. The encoding process of the URLLC traffic data may be unchanged. For the already scheduled eMBB transmission, some changes may be needed for the eMBB encoding. As an example, a part of the eMBB transmission, i.e. the transmission of the eMBB traffic data, may need to be jointly encoded with the shared payload from the URLLC. With reference to FIG. 9, the shared bits 1 and the shared bits 2 are two embodiments that are provided in the present disclosure. The shared bits 1 represent all of the message of the URLLC traffic data that may be encoded with the eMBB traffic data; and the shared bits 2 represent the part of the message of the URLLC traffic data or part of the URLLC encoded bits that may be encoded with the eMBB traffic data. As another example, the amount of resources of the eMBB transmission, i.e. the second resource, will be reduced, because the eMBB transmission may now avoid the transmission on the resources that overlap with the URLLC transmission, to improve the reliability of the URLLC transmission. That is, the eMBB traffic data may be transmitted in a part of the eMBB resource that does not overlap with the URLLC resource.

In some other embodiments, the first information is sent or received along with transmission of the first traffic data, and where the first information is configured. For example, the resource of the first information may be configured in advance by the second communication device. Therefore, the second communication may know there is potential information coming at the configured resource, so the second communication can decode the received first information. After the second communication decodes the first information, the second communication can decode the first traffic data with the help of the first information. In some embodiments, the first information is included in configured grant control information used for configured grant or grant free transmission, which may include indication of one or more parameters used for configured grant transmission. Configured grant (CG) control information may be information whose transmission resource has been configured. As an example, the first information may be a configured grant (CG)-UCI for CG or GF transmission in an unlicensed band in the current NR standard. As another example, the first information may be loaded in the CG-UCI or indicated by the CG-UCI. CG-UCI may already include information for CG or GF transmission, such as new data indicator (NDI), redundancy version (RV), HARQ process number or ID etc. In some embodiments, the first information is sent or received in a PUSCH or a MAC-CE.

Similarly, in some other embodiments, the second information is sent or received along with transmission of the first traffic data, and where the second information is configured. In some embodiments, the second information is configured grant information used for configured grant or grant free transmission. In some embodiments, the second information is sent or received in a PUSCH or a MAC-CE.

FIG. 10 is a block diagram illustrating the first information and/or the second information to be transmitted together with the first traffic. Herein, the first communication device is taken a UE as an example, and the second communication device is taken a gNB or a BS as an example. Also, the first traffic data is taken URLLC traffic data as an example, and the second traffic data is taken the eMBB traffic data as an example. Note that, the following description about FIG. 10 will not limit the present disclosure.

In brief, FIG. 10 may aim at the scenarios as follows. The GF/configured grant (CG) resource is available for the URLLC transmission (but may conflict with the eMBB transmission). A CG-UCI has been configured (for example, the mechanism is currently already being used in CG transmission for the unlicensed band).

In brief, here are solutions as follows. The UE decides to perform mixed traffic coding at the eMBB resources. The CG-UCI is sent along with GF/CG URLLC traffic data. Mixed traffic indication may be included in the CG-UCI. Another scenario is for the UE to transmit an UCI together with URLLC traffic. This usually applies to the scenario where a UCI is configured in advance, and the UCI can be transmitted together with an UL data transmission (e.g. together with URLLC traffic).

Some of the scenarios in FIG. 10 are similar to the scenarios in FIG. 9, the BS has already scheduled the eMBB transmission for the UE and the URLLC traffic data arrives for the same UE (intra-UE) after the eMBB transmission is scheduled and before the eMBB transmission is finished. And the URLLC traffic data can be sent in configured URLLC resources that may be overlapped (fully or partially overlapped) with the eMBB resources as in the previous scenarios. The difference from the scenarios in FIG. 9 is that the UCI can be sent together with the URLLC traffic data rather than afterwards. The UCI resource and content may be configured in advance such that the BS knows there is a potential UCI coming at the configured resource, and hence the BS knows how to decode the UCI that includes, is or indicates the first information and/or the second information. And it can first decode the UCI and then decode the URLLC traffic data, and then proceed to attempt to decode the joint encoded mixed traffic data, i.e. the eMBB traffic data. One example of such a mechanism is the configured grant (CG)-UCI used for configured grant or grant free transmission in the unlicensed band in the current NR standard. The CG-UCI is configured by the BS such that the UE can send the CG-UCI together with uplink data in a PUSCH configured for configured grant transmission. The CG-UCI may contain some information like HARQ process number, redundancy version (RV) etc., such that the UE can choose these parameters and the BS can obtain them first before decoding the data. When the CG-UCI or similar UCI is used for the mixed traffic coding purpose, some fields to indicate mixed traffic coding and related parameters can be added in the CG-UCI (or similar UCI) such that after decoding such UCI, the BS may obtain enough information to understand and try to decode the URLLC traffic data as well as mixed traffic coding scheme that can be used to decode the eMBB traffic data. The UCI can also be sent in a MAC-CE of the URLLC traffic data; however, this may require the BS to decode the URLLC traffic data first to be able to understand the UCI content, which can be further used to decode the mixed traffic code, i.e. the eMBB traffic data.

In some embodiments, the message of the second traffic data encoded with a part or all of the message of the first traffic data is a transport block (TB), a code block (CB) or a code block group (CBG). The joint mixed traffic coding on the second traffic data can be applied to the whole TB, or it can be applied to one of CB(s) or CBG(s). For example, a TB includes one or more CBG(s); and a CBG includes one or more CB(s).

In some embodiments, the CB encoded with a part or all the message of the first traffic data is the first one of one or more CBs that has an overlapped resource with the first resource. For CBG(s), in some embodiments, the CBG encoded with a part or all the message of the first traffic data is the first one of one or more CBGs that has an overlapped resource with the first resource. And transmission of other CBs or CBGs will not be affected by the joint mixed traffic coding scheme. In some other embodiments, the chosen CB or CBG may be any one, rather than the first one that has an overlapped resource with the first resource.

According to the embodiments about encoding the first CB that has an overlapped resource, since applying joint mixed traffic coding at the CB level, there is potentially a CB-based HARQ feedback available. Thus, if the particular CB of the second traffic data is affected by the first traffic data, only that CB needs to be retransmitted, which may decrease expense for retransmission. The advantage of encoding the first CBG that has an overlapped resource is similar to the contents about the first CB.

As the amount of resource for the transmission of the second traffic data is less than the originally scheduled second resource due to part of the second resource is not used for the second traffic data, the first communication device may need to either reduce the amount of the payload of the second traffic data, or change the code rate of the second traffic data.

In some embodiments, the transport block size (TBS) of the second traffic data is determined according to a non-overlapping resource of the TB; or, the size of the CB or the CBG is determined according to a non-overlapping resource of the CB or the CBG. For example, if joint mixed traffic coding is applied to the TB level, then the TBS of the TB of the second traffic data may be recalculated based on newly available part of the second resource that is not overlapped with the first resource, and target modulation and coding scheme (MCS) of the second traffic data is not changed. Similarly, if joint mixed traffic coding is applied to the CB or CBG level, then the size of the CB or CBG of the second traffic data may be recalculated based on the newly available part of the second resource that does not overlap with the first resource, and target MCS of the second traffic data is not changed. Changing the TBS or the size of CB or CBG without changing target MCS is easy to achieve.

In some other embodiments, rate matching of the second traffic data is performed on a non-overlapping resource of the TB, the CB or the CBG. For example, having the TBS or size of CB or CBG of the second traffic data remain the same, rate matching on the remaining part of the second resource is performed at either TB, CB or CBG level. In this case, the code rate of transmission of the second traffic data can be changed in comparison to the target MCS that is already scheduled before.

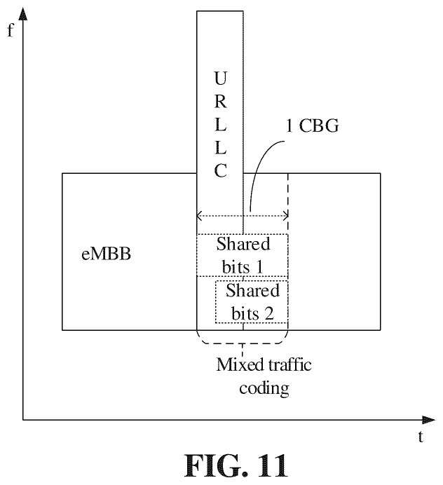

FIG. 11 is a block diagram illustrating a multiplexing/encoding embodiment. Herein, the first communication device is taken a UE as an example, and the second communication device is taken a gNB or a BS as an example. Also, the first traffic data is taken URLLC traffic data as an example, and the second traffic data is taken eMBB traffic data as an example. Note that, the following description about FIG. 11 will not limit the present disclosure.

The embodiment shown in FIG. 11 may be applicable to all the scenarios described in this disclosure. FIG. 11 shows a URLLC/eMBB multiplexing method that includes performing mixed traffic coding only on first CBG that overlaps with the URLLC resource, as shown by doted-line double arrows in FIG. 11. Then, to keep the eMBB resource being used as scheduled, the UE can reduce the eMBB payload for this CBG, or increase the code rate of eMBB transmission by rate matching. The skilled in the art can understand that the embodiment about performing mixed traffic coding only on first CB or TB that overlaps with the URLLC resource is similar to the embodiment as shown in FIG. 11.

FIG. 11 shows an example of mixed traffic coding in the scenario when there is an overlap between URLLC transmission resources and eMBB transmission resources. If there are resources configured that can be used for URLLC (e.g. in GF or CG transmission) to satisfy its latency requirement, the UE can perform the URLLC transmission on the configured resources. The configured URLLC resources may be overlapped (fully or partially overlapped) with the eMBB resources. However, if there is no overlap between the configured URLLC resource and the scheduled eMBB resource, the UE can still perform mixed traffic coding scheme in the eMBB resources. If the UCI is configured on the GF/CG resources, the UCI can be sent together with the URLLC traffic data on the configured URLLC resources as described in the previous embodiments. If there are no scheduled or no configured resources (outside of the scheduled eMBB resources) available to transmit the URLLC traffic data, the UE may decide to use a part of the scheduled eMBB resource to transmit the URLLC traffic data and to perform joint mixed traffic coding on a part or all of the rest of the scheduled eMBB resources.

Since the URLLC resources can be overlapped with a part of the eMBB resources (e.g. occupying part of eMBB time frequency grid), to avoid potential interference with the URLLC transmission, the actual eMBB transmission or the joint mixed traffic coding of the eMBB part should use the rest of the originally-scheduled eMBB resources that is not overlapped with the URLLC resources. To perform joint mixed traffic coding of the eMBB traffic data on the remaining eMBB resources, the UE can share part or all of the payload to jointly encode with the eMBB traffic data for the mixed traffic coding. The joint mixed traffic coding on the eMBB traffic data can be applied to the whole eMBB transport block (TB) or it can be applied to one of eMBB code blocks (CBs) or code block groups (CBGs). The CB or CBG can be chosen as the first CB or CBG that has resources that overlap with the URLLC resources. And transmission of other CBs or CBGs will not be affected by the joint mixed traffic coding scheme. One of the advantages of applying joint mixed traffic coding at the CBG level is that there is potentially a CBG-based HARQ feedback available. Thus, if the particular CBG of the eMBB traffic data is affected by the URLLC traffic data, only that CBG needs to be retransmitted.

As the amount of resources for eMBB transmission is now less than the originally-scheduled eMBB resources, the UE may need to either reduce the amount of the eMBB payload or change the code rate for the eMBB transmission. When the eMBB payload is reduced, the transport block size (TBS) needs to be recalculated based on the new available eMBB resources. If joint mixed traffic coding is applied to the eMBB TB level, then the TBS of the eMBB TB is recalculated based on the newly available eMBB resources that do not overlap with URLLC resources. For example, the recalculation may be performed based on the new number of resource elements (REs) where the target MCS for eMBB is unchanged. If joint mixed traffic coding is applied on one of the eMBB CB or CBG, only the size of that CB or CBG that overlaps with URLLC resource may need to be recalculated and target MCS of eMBB can be unchanged.

Another solution is to have TBS (and size of CB or size of CBG) of eMBB all remain the same (as with a typical non-URLLC overlap case), and rate matching on the remaining eMBB resource is performed at either TB, CB or CBG level. In this scenario, the code rate of the eMBB transmission can change in comparison to the target MCS that is already scheduled for the eMBB transmission.

In some embodiments, the second information indicates that the second traffic data is transmitted in the codeword generated by encoding the part or all of the message of the first traffic data and the message of the second traffic data together. For example, the second information includes an indicator that indicates the second traffic data is transmitted in the above codeword, and the indicator may be called mixed traffic indication and serve as a 1-bit indicating whether mixed traffic coding is performed.

According to the embodiments, the second information may indicate the second traffic data is mixed traffic, such that the second communication device can understand and decode the second traffic data.

In some embodiments, the second information further indicates the ratio of the part or all of the message of the first traffic data used for encoding with the second traffic data and a total message of the first traffic data. For example, the second information includes an indicator that indicates the ratio of them, and the indicator may be called a coupling ratio, which can be defaulted to 1 if all the message of the first traffic data is embedded into the message of the second traffic data.

According to the embodiments, the second information may further indicate the coupling ratio, such that the second communication device can further understand and decode the second traffic data.

In some embodiments, the second information further indicates identification of the part or all of the message of the first traffic data and the message of the second traffic data. For example, the identification may indicate TB, CBG or CG of the first traffic data or the second traffic data.

With reference to FIG. 11, some embodiments are provided as follows. Herein, the first communication device is taken a UE as an example, and the second communication device is taken a gNB or a BS as an example. Also, the first traffic data is taken URLLC traffic data as an example, and the second traffic data is taken the eMBB traffic data as an example. The second information may be loaded in UCI. Note that, the following description about FIG. 11 will not limit the present disclosure. For the GF/CG URLLC transmission, no change needs to be made on the URLLC transmission and the UCI signaling. If the URLLC resource is configured (GF/CG), only changes for the eMBB overlapped CBG may be needed to indicate: mixed traffic indication (may serve as 1 bit); identification of eMBB CBG (e.g. CBG index+HARQ process ID or symbol/slot index); and coupling ratio. If the URLLC resource is not configured, the UCI needs to indicate additionally for the URLLC transmission: URLLC starting symbol, resource ratio (#, i.e. number of symbols). More details are provided as follows.

The UCI that is sent needs to inform the BS about the mixed traffic coding to help the BS decode the mixed traffic. When a URLLC resource is already configured (e.g. in GF or CG transmission), the URLLC transmission may be unaffected by mixed traffic coding; accordingly, no change needs to be made for the URLLC transmission. However, the UCI needs to indicate the eMBB mixed traffic coding.

The indication may include:
a. 1 bit for indicating whether mixed traffic coding is performed.
b. Coupling ratio, which is the ratio of the shared payload of the URLLC traffic data used for mixed traffic code to the total URLLC transmission payload.
And this can be defaulted to 1 if all the URLLC payload is embedded into the eMBB payload for joint encoding. In some other scenarios, the message may indicate the number of bits in URLLC traffic that is used for sharing or coupling with the eMBB data through other means.
c. Identification of the URLLC and the eMBB TB/CB/CBG used for mixed traffic coding. As an example of TB level, the identification may include two HARQ process numbers, one used to identify the URLLC TB that is used for mixed traffic coding (to identify the shared payload), another HARQ process number is used to identify the eMBB TB used for mixed traffic coding. As an example of CB or CBG level, if only 1 CB/CBG index of eMBB transmission is used for mixed traffic coding, the UCI may further include the CB/CBG index to identify the CB/CBG within the TB for mixed traffic coding. Additionally or alternatively, the UCI may indicate a time and/or frequency location/size to indicate the eMBB CB/CBG or TB for the mixed traffic coding, the time frequency location/size can be symbol/slot index, number of symbols/slots, starting resource block (RB) index and number of RBs etc. In some scenarios, the UCI may include additional coding or resource information of joint mixed traffic coding if it is needed for the BS to identify the resource used as well as encode parameters for the mixed traffic coding.

As mentioned before, the UCI for mixed traffic coding can be sent in a PUCCH or a PUSCH or a MAC-CE channel. If sent in the PUCCH, there may be a PUCCH resource configured in a radio resource control (RRC) information or DCI. The PUCCH resource can be periodic resources or a one-time scheduled resource. If the UCI is sent in the PUSCH or the MAC-CE, there may be UCI configurations defining parameters on which the PUSCH the UCI can be sent.

Dropping the eMBB PUSCH transmission has a significant impact on eMBB throughput and latency. The resources that are already scheduled may not have enough time to be redistributed for the UE. Mixed traffic coding for UL intra-UE conflict handling instead of dropping eMBB data may achieve the one or more of the following advantageous effects. Mixed traffic coding can maintain majority of throughput of transmission of the eMBB. The URLLC reliability is enhanced with mixed traffic coding. Only 1 CBG of the eMBB traffic data is impacted, which, if undecoded, can be identified based on CBG-based feedback. For the embodiments about TB or CB level, only 1 TB or 1 CG of the eMBB traffic data is impacted.

In the present disclosure, the UE makes decisions on mixed traffic coding without waiting for DCI, and sends UCI afterwards or together with the transmission to help the BS (gNB) decode the data, which may achieve the one or more of the following advantageous effects. If the UE waits until the BS sends DCI for mixed traffic coding, the URLLC traffic data may be significantly delayed. Only small amount of the eMBB traffic data is impacted by the URLLC traffic data and can be recovered with the help of UCI. When the CG-UCI is configured, the CG-UCI can be re-utilized for indication of mixed traffic coding.

Although the solutions proposed in this disclosure may be focused on a mixed traffic coding technique for conflict handling, the conflict resolution mechanism (i.e., that of the UE deciding to transmit the URLLC traffic data in the overlapped eMBB resource and using the remaining of resources for the eMBB traffic data) may be applicable to other eMBB coding applications (i.e., other than mixed traffic coding). For example, a UE may decide to transmit the URLLC traffic data in a GF resource (partially) overlapped with eMBB or in part of eMBB resources. The UE can puncture the eMBB transmission in the resource overlapping with the URLLC resources or perform rate matching (with respect to the eMBB encoding) on the remaining eMBB resources that do not overlap with the URLLC resources, without mixed traffic coding. The UE can then send UCI afterwards or together with the URLLC traffic data to the BS to inform the BS that the eMBB transmission is punctured or rate matched due to the URLLC transmission.

The person skilled in the art can understand that solutions in the present disclosure are primarily focused on a UE sending UCI at the time or afterwards to inform a BS about the mixed traffic coding. In the scenario that a BS knows the URLLC is coming (e.g. through receiving an SR) and there is enough time for the BS to send DCI and enough time for the UE to process it, instead of sending CI to the UE to cancel the rest of eMBB transmission, the BS may instead send DCI to schedule the mixed traffic coding and inform the UE the parameters and resources necessary for the UE to perform mixed traffic coding. The DCI can indicate all the parameters needed for the UE to perform the mixed traffic coding, including part or all of the parameters described in the UCI contents for mixed traffic coding in this disclosure.

Herein some embodiments about mixed traffic coding are further provided. In mixed traffic coding, the scenario considers multiple services (at least two services) with different traffic types. The first traffic type (e.g. URLLC) may be protected by a small code (small code length) while the second traffic type (e.g. eMBB) may be protected by a larger code because of large payload. The main idea of mixed traffic coding is to embed part or all of the information bits from the small code into the payload of the larger code and encode (e.g., using an error-correction code) them together in the larger code. Decoding the small code can enhance the decoding of the larger code. While decoding of larger code can also improve the reliability of the small code if the small code cannot be independently decoded, which reduces the likelihood of requiring retransmission of the small code.

Some embodiments of the present disclosure add a new procedure between a decoding failure and the request for a retransmission. This is achieved by integrating various services into a single forward error correction (FEC), with awareness of service priority (target block error rate (BLER), latency and sources). Meanwhile, a corresponding channel coding method supports both self decodability of one or more individual payloads and enhanced joint decodability of such individual payloads. Individual payloads may also be referred to as blocks, constituent payloads, or short or shorter messages or payloads, and are part of a larger payload. A larger payload may also be referred to as a longer or payload, a combined payload, or a code block. Payloads, messages, and code blocks, as used herein refer to bits before channel encoding or after channel decoding.

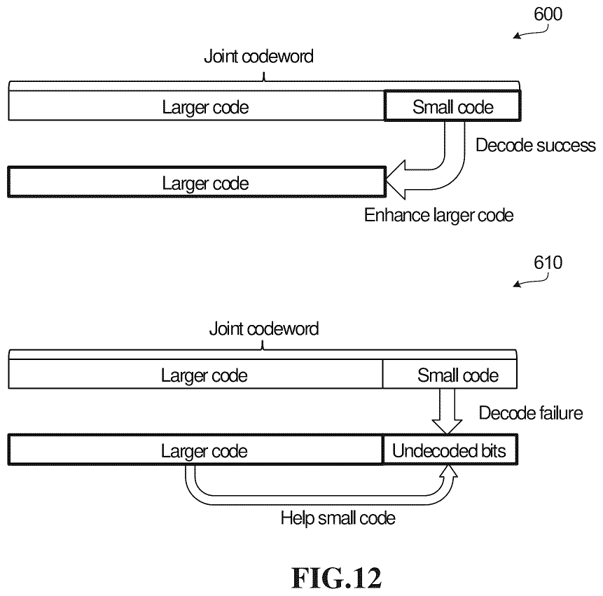

In one possible self-decodable joint coding design, each of one or more individual payloads, which may correspond to different services for example, can be self-decoded, and at the same time support joint decoding to further enhance performance. FIG. 12 is a block diagram illustrating self-decoding at 600, and joint-decoding in the event of a self-decoding failure, at 610.

Some embodiments support multiple decoding attempts before requesting retransmission. Joint decoding, for example, may in effect be inserted or attempted between a decoding failure and a retransmission request. Some embodiments of the present disclosure include the following main points.

Point 1: a three-decoding-attempt transmission paradigm, where a new procedure called joint decoding is inserted between a decoding failure and a retransmission request.

[First decoding attempt 600] A receiver (for example, the second communication device) for decoding the 1st payload after receiving the corresponding minimum required code bits (LLRs). If the decoding of the 1st payload is successful, it uses the correctly decoded bits to enhance the decoding performance of a 2nd payload after the corresponding minimum required code bits are received.

[Second decoding attempt 610] If the decoding of the 1st payload fails, the receiver will not request a retransmission immediately, but proceed to jointly decode with the 2nd payload. After the decoding of the 2nd payload (no matter success or failure), the joint decoding feature ensures that the 1st payload will be successfully decoded with a high probability.

[Third decoding attempt] If the decoding of the 1st payload still fails after the second decoding attempt, the receiver will request a retransmission from the transmitter (for example, the first communication device). This will incur some delay, but the receiver will decode at least a third time with both the joint code word and the retransmitted code word.

Point 2: a self-decodable joint coding design, such that each individual payload (e.g., corresponding to a service) can be self-decoded, and at the same time support joint decoding to further enhance performance. Several small or shorter messages may be embedded or otherwise combined into a longer code block or payload. Small messages are self-decodable, meaning they can be decoded after collecting a subset of the code bits (or symbols, log-likelihood ratios (LLRs)). The subset of code bits is also a standalone short code. Two or more small messages are jointly-decodable. The corresponding subsets of the code bits combine into a longer code. This is done through “coupling” between bits from the two messages. Specifically, all or a subset of the first message (here message means information bits, i.e., bits before encoding) is copied and combined with the second message. The combined message is encoded into a second code word.

The bits from the first message can be directly copied and appended to the second message. The bits from the first message can be transformed (e.g., multiplying with a binary matrix) and appended to the second message. Although information bit (or message) coupling is presented as an example, it is also feasible to use coded bits for coupling. In the case of systematic codes, message bits are also part of the code bits, and thus the two alternatives become the same.

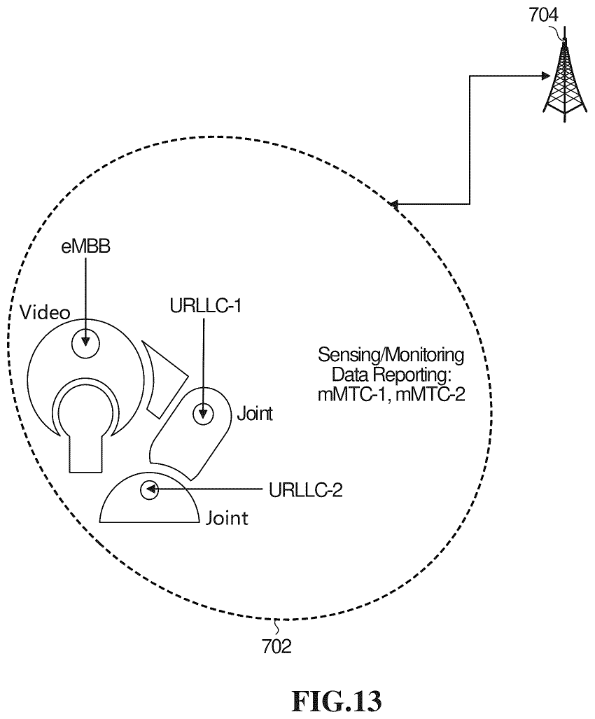

Consider now an example in which a device such as a robot arm communicates with a network device such as a base station, and supports URLLC, eMBB and mMTC services. Suppose that the device's video stream data transmissions belong to an eMBB service, signaling for controlling each of one or more joints of the robot arm belongs to a URLLC service, and delay-insensitive sensing or monitoring data reporting belongs to an mMTC service. FIG. 13 is a block diagram illustrating this example, in which a robot arm 702 including a video device and two joints communicates with a BS 704.

A potential application scenario is described as follows. A device (e.g., robot arm) communicates with a BS and supports URLLC, eMBB and mMTC services. The video surveillance data transmissions may belong to eMBB service, the signaling for controlling joints may belong to URLLC service, and some delay-insensitive sensing/monitoring data report may belong to mMTC.

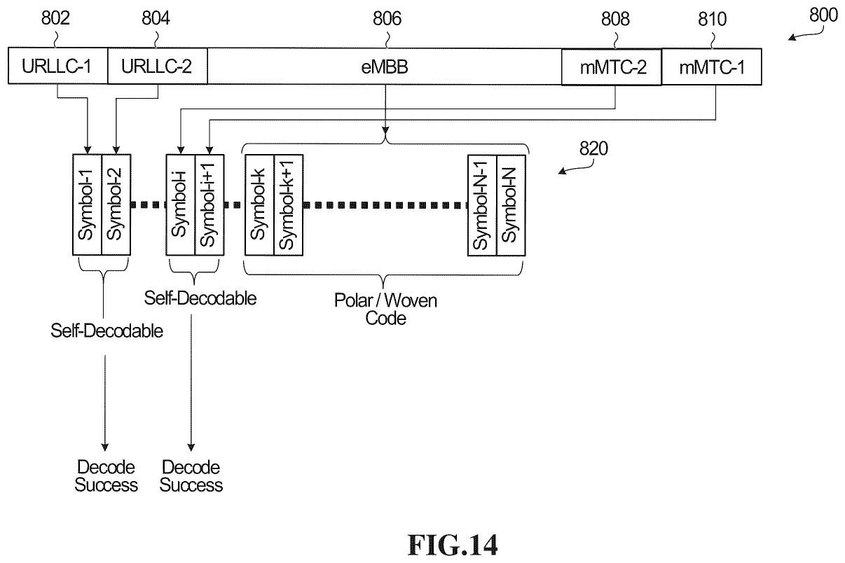

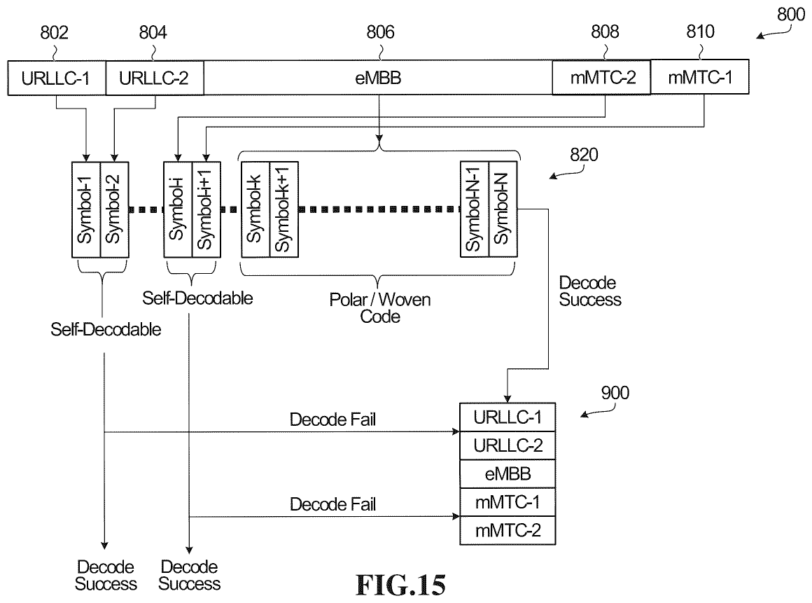

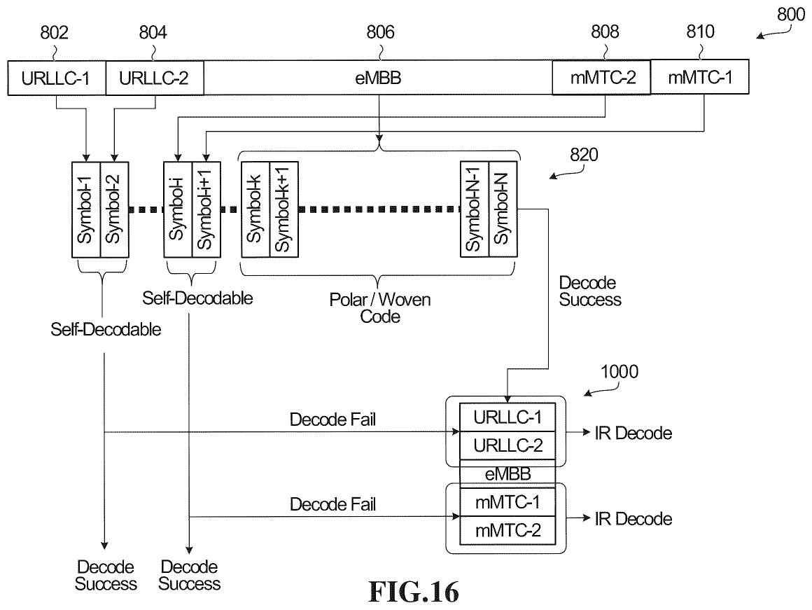

FIG. 14 is a block diagram illustrating an example code block and encoded symbols according to an embodiment. In FIG. 14, and similarly in FIGS. 15 and 16 described below, 800 represents a code block or combined payload that includes individual payloads 802, 804, 806, 808, 810. The individual payloads 802, 804, 806, 808, 810 include payloads that are associated with different services in the example shown. The code block 800 is channel encoded to generate a codeword 820 for transmission. The codeword 820 is generated by encoding the individual payloads with an error correction code. Polar code or woven code is illustrated for the eMBB individual payload as an example. Other codes, including different codes for different individual payloads, are possible. The codeword 820 is also shown as including N symbols, but symbols are intended solely as an illustrative example of parts of a codeword. The arrangement of symbols shown at 820 is also an example that is intended to illustrate one possible decoding order. FIG. 14, and similarly FIGS. 15 and 16, should be interpreted accordingly. Augmented eMBB coding including a joint code block includes symbols/bits corresponding to URLLC, eMBB and mMTC packets. Each URLLC, eMBB, or mMTC packets are self-decodable. Typically, URLLC bits/symbols may be placed at the beginning of the code block, followed by eMBB bits/symbols, and then mMTC bits/symbols.

A decoder (for example, the second communication device) first attempts to decode the short packets, e.g., URLLC, labelled Symbol-1 and Symbol-2 in FIG. 14. For illustrative purposes, the URLLC individual payloads are shown as being encoded into respective self-decodable encoded symbols, but in other embodiments, encoding is based on service type, and 802, 804 are treated as one individual payload and are self-decodable together as one individual payload. If the URLLC packet can be successfully decoded, its coupled bits in the eMBB packets can augment the decoding of eMBB. The decoder can choose either to decode the eMBB packet, or the mMTC packets next. If the eMBB packet is decoded next and is successfully decoded, then the mMTC packets can be decoded with lower error probability; otherwise, if the mMTC packets are decoded next and are successfully decoded, then the eMBB packet can be decoded with even lower probability.

The augmented decoding of a second packet, which may include one or more eMBB packets in the examples above, after the successful decoding of a first packet which may include one or more URLLC packets and/or one or more mMTC packets in the examples above, is due to the coupling of information bits or coded bits between the two packets. In the case of coupled information bits, the other packet will have fewer information bits but its packet length remains the same, which means lower code rate. In the case of coupled coded bits, the other packet will have shortened code bits which are pre-known to the decoder, which also means lower code rate. In both cases, the code rate of at least another self-decodable codeword (say eMBB) can be reduced, therefore resulting in improved performance.

FIG. 15 is a block diagram illustrating an example code block and encoded symbols according to another embodiment. The code block 800 and encoded symbols 820 are the same as those shown in FIG. 14, but FIG. 15 illustrates different decoding at 900, which may be referred to as HARQ-less URLLC. One option is that if a self-decodable packet (say URLLC for example) fails to decode, instead of requesting a retransmission, the receiver proceeds to decode another self-decodable packet (say eMBB for example). If the latter self-decodable code word is successfully decoded, the code rate of the former can be reduced, resulting in an improved performance. Another option is that if a self-decodable packet (say URLLC for example) fails to decode, instead of requesting a retransmission, the receiver proceeds to jointly decode the entire code block consisting of URLLC, eMBB and mMTC. If the joint code word is successfully decoded, all the bits at 800 can be correctly recovered. In one example shown in FIG. 15 at 900, if both URLLC decoding and mMTC decoding fail, then joint decoding can still be successful.

There are also two modes for coupling between URLLC symbols and eMBB symbols. The first is referred to herein as “tight coupling” but may also be known by other names. In tight coupling, the coupling is within one slot or code block. The second is referred to herein as “loose coupling” but may also be known by other names. In loose coupling, the coupling is between two consecutive slots or code blocks.

FIG. 16 is a block diagram illustrating an example code block and encoded symbols according to a further embodiment. The code block 800 and encoded symbols 820 are the same as those shown in FIGS. 14 and 15, but FIG. 16 illustrates different decoding at 1000, which may be referred to as HARQ-less URLLC with incremental redundancy (IR) combining. In some embodiments, there may be multiple decoding attempts without requesting retransmission, such as shown in FIGS. 14 and 15 above, and if those decoding attempts fail, then a receiver may request retransmission using incremental redundancy HARQ. This type of approach may still be referred to as “HARQ-less” in the context of the multiple decoding attempts before a first retransmission request is transmitted by a receiver and received by a transmitter, and HARQ-less URLLC with IR as referenced above adds the option of a retransmission request after multiple unsuccessful decoding attempts. That is, only if the above second decoding attempts fail again, the receiver requests retransmission using incremental redundancy HARQ.

For example, a retransmission preferably contains the incremental code bits for the first message (URLLC in this example shown in FIG. 16), because a successful decoding of the first message will increase the chance of successful decoding for the subsequent messages. Optionally, the retransmission may contain incremental code bits for the subsequent messages too, in order to further enhance decoding performance.

After receiving the retransmitted bits/symbols, the receiver will perform similar decoding attempts as mentioned above.

There are several possible ways to perform self-coding and joint-coding. For example, the packets or payloads can be coupled in a chain structure, or coupled in a star structure.

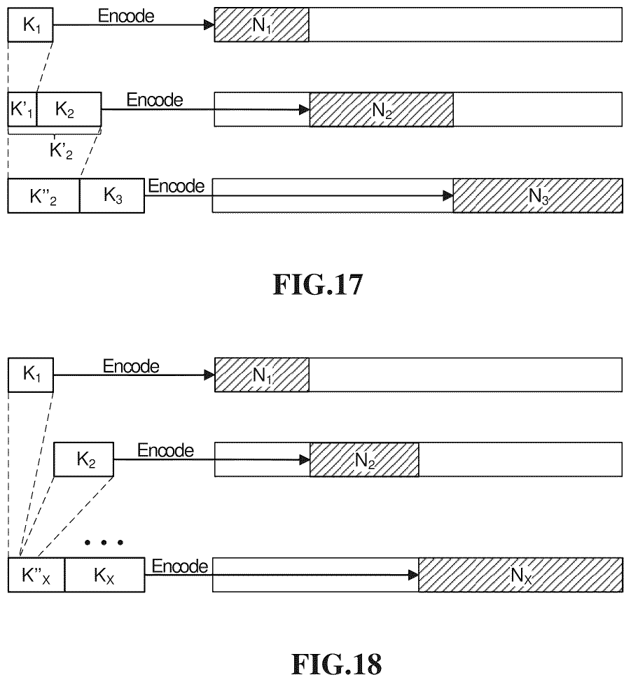

FIG. 17 is a block diagram illustrating sequential coupling of bits between individual payloads, according to a sequence or chain structure. This type of encoding approach to provide or support self-decoding and joint-decoding may also or instead be referred to as successive embedding, to capture the notion that information bits from one individual payload are embedded or otherwise combined with information bits of another individual payload. The first approach is referred to herein as successive embedding. The encoding procedures are as follows:
K1 information bits (e.g., URLLC) are encoded into N1 code bits, the code rate is R1=K1/N1.

Take the K′1 bits (from the K1 bits, so K′1≤K1) and K2 additional bits (e.g., eMBB). The combined K′2=K′1+K2 bits are encoded into N2 code bits. The code rate is R2=K′2/N2>R1.

Take the K″2 bits (from the K′2 bits, so K″2≤K′2) and K3 additional bits (e.g., mMTC). The resultant K″3=K″2+K3 bits are encoded into N3 code bits. The code rate is R3=K″3/N3>R2.

A joint codeword includes the N1 code bits, the N2 code bits, and the N3 code bits. This type of sequential or successive embedding may be repeated for more individual payloads, or in some embodiments there may be fewer than three individual payloads.

FIG. 18 is a block diagram illustrating what may be referred to as multi-to-one coupling of bits between individual payloads, according to a star structure. This type of encoding approach to provide or support self-decoding and joint-decoding may also or instead be referred to as multi-to-one embedding, in which information bits from multiple different individual payloads are embedded or otherwise combined with information bits of one other individual payload.

K1 information bits (e.g., associated with an URLLC service) are encoded into N1 code bits, and the code rate is R1=K1/N1. K2 information bits (e.g., associated with an mMTC service) are encoded into N2 code bits, and the code rate is R2=K2/N2.

The operation in the above fashion may be repeated if there are more than two individual payloads to be coupled to another individual payload.

Take the K′1 bits (from the K1 bits, so K′1≤K1), the K′2 bits (from the K2 bits, so K′2≤K2), and others to combine into K″x bits. Gather the K″x bits and the Kx additional bits (e.g., for eMBB) into K′x=K′x+Kx bits, and encode the K′x bits into Nx code bits. The code rate is Rx=K′x/Nx>R1, Rx>R2, and so on.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing a program for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, a program stored in or on a non-transitory computer readable storage medium may include instructions to, or to cause a processor to, decide to transmit, by a first communication device to a second communication device in a wireless communication network, first traffic data in a first resource overlapping with a second resource. A program may also or instead include instructions to, or to cause a processor to, send, by the first communication device to the second communication device, first information such that the second communication device is able to decode the first traffic data. The second resource is scheduled for transmission of second traffic data by the second communication device.

Embodiments related to apparatus or non-transitory computer readable storage media may include any one or more of the following features, for example, which are also discussed elsewhere herein:
the first resource is configured for grant free transmission or configured grant transmission;
the first resource is a part of the second resource;
the first information is sent after transmission of the first traffic data;
the first information is sent in a PUCCH, a PUSCH or a MAC-CE;
the first information is sent along with transmission of the first traffic data, and the first information is configured;
the first information is configured grant information used for configured grant or grant free transmission;
the first information is sent in a PUSCH or a MAC-CE;
the program further includes instructions to, or to cause the processor to, send, by the first communication device to the second communication device, second information such that the second communication device is able to decode the codeword of the second traffic data;
the second traffic data is transmitted in a codeword generated by encoding a part or all of the message of the first traffic data and a message of the second traffic data together;
the program further includes instructions to, or to cause the processor to, decide to encode the part or all of the message of the first traffic data and the message of the second traffic data together;
the message of the second traffic data is a transport block (TB), a code block (CB) or a code block group (CBG); the CB is the first one of one or more CBs that has an overlapped resource with the first resource;
the CBG is the first one of one or more CBGs that has an overlapped resource with the first resource;
the transport block size (TBS) of the second traffic data is determined according to a non-overlapping resource of the TB; or, the size of the CB or the CBG is determined according to a non-overlapping resource of the CB or the CBG;
rate matching of the second traffic data is performed on a non-overlapping resource of the TB, the CB or the CBG;
the program further includes instructions to, or to cause the processor to, send, by the first communication device to the second communication device, second information such that the second communication device is able to decode the codeword of the second traffic data;
the second information is sent along with the first information;
the second information is sent in a PUCCH, a PUSCH or a MAC-CE;
the second information is sent along with transmission of the first traffic data, and the second information is configured;
the second information is configured grant information used for configured grant or grant free transmission;
the second information is sent in PUSCH or MAC-CE;
the second information indicates that the second traffic data is transmitted in the codeword;
the second information further indicates the ratio of the part or all of the message of the first traffic data and the total message of the first traffic data.

A program stored in or on a non-transitory computer readable storage medium may also or instead include instructions to, or to cause a processor to, receive, by a second communication device from a first communication device in a wireless communication network, first traffic data in a first resource overlapping with a second resource. A program may also or instead include instructions to, or to cause a processor to: receive, by the second communication device from the first communication device, first information. A program may also or instead include instructions to, or to cause a processor to: decode the first traffic data according to the first information. The second resource is scheduled for transmission of second traffic data by the second communication device.

Embodiments related to apparatus or non-transitory computer readable storage media may include any one or more of the following features, for example, which are also discussed elsewhere herein:
the first resource is configured for grant free transmission or configured grant transmission;
the first resource is a portion of the second resource;
the first information is received after transmission of the first traffic data;
the first information is received in a physical uplink control channel (PUCCH), a physical uplink shared channel (PUSCH) or a medium access control-control element (MAC-CE);
the first information is received along with transmission of the first traffic data, and the first information is configured;
the first information is configured grant information used for configured grant or grant free transmission;
the first information is received in a PUSCH or a MAC-CE;

the program further includes instructions to, or to cause a processor to, receive, by the second communication device from the first communication device, the second traffic data in a portion of the second resource that does not overlapped with the first resource;
the second traffic data is received in a codeword generated by encoding a part or all of a message of the first traffic data and a message of the second traffic data together;
the message of the second traffic data is a transport block (TB), a code block (CB) or a code block group (CBG);
the CB is the first one of one or more CBs that has an overlapped resource with the first resource;
the CBG is the first one of one or more CBGs that has an overlapped resource with the first resource;
the transport block size (TBS) of the second traffic data is determined according to a non-overlapping resource of the TB; or, the size of the CB or the CBG is determined according to a non-overlapping resource of the CB or the CBG;
rate matching of the second traffic data is performed on a non-overlapping resource of the TB, the CB or the CBG;
the program further includes instructions to, or to cause a processor to, receive, by the second communication device to the first communication device, second information;
the program further includes instructions to, or to cause a processor to, receive, decode the codeword of the second traffic data according to the second information;
the second information is received along with the first information;
the second information is received in a PUCCH, a PUSCH or a MAC-CE;
the second information is received along with transmission of the first traffic data, and the second information is configured;
the second information is configured grant information used for configured grant or grant free transmission;
the second information is sent in PUSCH or MAC-CE;
the second information indicates that the second traffic data is transmitted in the codeword;
the second information further indicates the ratio of the part or all of the message of the first traffic data and the total message of the first traffic data;
the second information further indicates identification of the part or all of the message of the first traffic data and the message of the second traffic data.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store a program or instructions to perform any of various methods consistent with the present disclosure.

Although aspects of the present disclosure have been described with reference to specific features and embodiments thereof, various modifications and combinations can be made thereto without departing from the disclosure. The description and drawings are, accordingly, to be regarded simply as an illustration of some embodiments of the disclosure as defined by the appended claims, and are contemplated to cover any and all modifications, variations, combinations or equivalents that fall within the scope of the present disclosure. Therefore, although embodiments and potential advantages have been described in detail, various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
deciding to transmit, by a first communication device to a second communication device in a wireless communication network, first traffic data in a first resource overlapping with a second resource, wherein the second resource is scheduled by the second communication device for transmission of second traffic data by the first communication device; and
sending, by the first communication device to the second communication device, first information such that the second communication device is able to decode the first traffic data.

2. The method of claim 1, wherein the first resource is a part of the second resource.

3. The method of claim 1, wherein the first information is sent after transmission of the first traffic data or the transmission of the second traffic data.

4. The method of claim 1, wherein the first information is sent along with transmission of the first traffic data, and wherein the first information is configured-grant control information used for configured-grant transmission.

5. The method of claim 1, further comprising:
transmitting, by the first communication device to the second communication device, the second traffic data in a portion of the second resource that does not overlap with the first resource.

6. The method of claim 1, wherein the second traffic data is transmitted in a codeword generated by encoding a second message of the second traffic data together with a part or all of a first message of the first traffic data.

7. A method comprising:
receiving, by a second communication device from a first communication device in a wireless communication network, first traffic data in a first resource overlapping with a second resource, wherein the second resource is scheduled by the second communication device for transmission of second traffic data by the first communication device;
receiving, by the second communication device from the first communication device, first information; and
decoding the first traffic data according to the first information.

8. The method of claim 7, wherein the first information is received along with transmission of the first traffic data, and wherein the first information is configured grant control information used for configured grant or grant free transmission.

9. The method of claim 7, further comprising:
receiving, by the second communication device from the first communication device, the second traffic data in a portion of the second resource that does not overlap with the first resource.

10. The method of claim 7, wherein the second traffic data is received in a codeword generated by encoding a part or all of a first message of the first traffic data together with a second message of the second traffic data together.

11. A first communication device comprising:
at least one processor; and
a memory coupled to the at least one processor, the memory storing instructions that, when executed by the at least one processor, cause the first communication device to:
decide to transmit, to a second communication device in a wireless communication network, first traffic data in a first resource overlapping with a second resource, wherein the second resource is scheduled by the second communication device for transmission of second traffic data by the first communication device; and
send, to the second communication device, first information such that the second communication device is able to decode the first traffic data.

12. The first communication device of claim 11, wherein the first resource is a part of the second resource.

13. The first communication device of claim 11, wherein the first information is sent after transmission of the first traffic data or the transmission of the second traffic data.

14. The first communication device of claim 11, wherein the first information is sent along with transmission of the first traffic data, and wherein the first information is configured-grant control information used for configured-grant transmission.

15. The first communication device of claim 11, wherein the instructions further cause the first communication device to:
transmit, to the second communication device, the second traffic data in a portion of the second resource that does not overlap with the first resource.

16. The first communication device of claim 11, wherein the second traffic data is transmitted in a codeword generated by encoding a second message of the second traffic data together with a part or all of a first message of the first traffic data.

17. A second communication device comprising:
at least one processor; and
a memory coupled to the at least one processor, the memory storing instructions that, when executed by the at least one processor, cause the second communication device to:
receive, from a first communication device in a wireless communication network, first traffic data in a first resource overlapping with a second resource, wherein the second resource is scheduled by the second communication device for transmission of second traffic data by the first communication device;
receive, from the first communication device, first information; and
decode the first traffic data according to the first information.

18. The second communication device of claim 17, wherein the first information is received along with transmission of the first traffic data, and wherein the first information is configured grant control information used for configured grant or grant free transmission.

19. The second communication device of claim 17, wherein the instructions further cause the second communication device to:
receive, from the first communication device, the second traffic data in a portion of the second resource that does not overlap with the first resource.

20. The second communication device of claim 17, wherein the second traffic data is received in a codeword generated by encoding a part or all of a first message of the first traffic data together with a message of the second traffic data together.
